(19) United States
(12) Patent Application Publication
(10) Pub. No.: US 2003/0012372 A1
(43) Pub. Date: Jan. 16, 2003

(54) System and method for joint encryption and error-correcting coding

(76) Inventor: Siu Lung Cheng, Tsuen Wan (HK)

Correspondence Address: Chiahua George Yu, Low Office of C. George Yu, 1250 Oakmead Pkwy., Ste. 210, Sunnyvale, CA, 94085, US

(21) Appl. No.: 09/999,073

(22) Filed: Nov. 15, 2001

Related U.S. Application Data
(60) Provisional application No. 60/286,446, filed on Apr. 25, 2001.

(51) Int. Cl. H04K 1/00

(52) U.S. Cl. 380/28

(57) ABSTRACT

Systems and methods for jointly performing encryption and error-correction coding offer advantages, especially in the presence of noise. According to one embodiment, a method for encryption and transmission of information includes: inserting at least one encryption key element into source data elements that are to be communicated, yielding an extended information sequence; encoding the extended information sequence using an error-correcting code, yielding an extended codeword; removing at least one element of the extended codeword, leaving a punctured extended codeword; and transmitting the punctured extended codeword across a medium. According to another embodiment, a system for decrypting information includes: means for receiving input data that includes error-correction code with missing elements and with errors, the missing elements being based on a key, the key already known on the receiving side of said transmission; and means for automatically decoding said input data based on the key to recover a message despite the errors.

### CROSS REFERENCE TO RELATED APPLICATIONS

The present application is related to and claims the benefit of priority from commonly-owned U.S. Provisional Patent Application No. 60/286,446, filed on Apr. 25, 2001, entitled “System and Method for Error-Correction Coding with Encryption Capability Using Systematic Convolutional Codes”.

### BACKGROUND INFORMATION

The present invention relates to cryptography. The present invention is especially applicable to cryptography for use in message transmission across a medium, either a noise-free medium or, especially, a possibly noisy medium.

The increasing use of data transmission in various fields such as telecommunication, cellular communication, satellite communication, wireless communication and networking has led to an increasing demand for systems that support data encryption, or cryptosystems. There are two kinds of cryptosystems, one is public key cryptosystems and the other is private key cryptosystems. In public key cryptosystems, there are two keys, one of which is public and the other of which is private. Well known public key cryptosystems include RSA and Elliptic curve encryption systems. In private key cryptosystems, there is only one key, which is used for both the encryption and decryption processes. Popular private key cryptosystems include DES and RC4.

When communicating over mediums that may be noisy, error-correcting codes are typically used to achieve communication reliability. Error-correcting codes can be divided into two categories: block codes and convolutional codes. Block codes have fixed block lengths for the codewords. In contrast, convolutional codes have flexible code lengths. Common block codes include Hamming codes and BCH codes. There are different classes of convolutional codes with different error-correcting capabilities. Among these codes, a relatively new class known as Turbo-Codes offers significant coding gain for power limited communication channels.

In typical communication systems, the encryption process is independent of the error-correcting encoding process. Data is generally first encrypted and is then separately encoded according to some standard, non-cryptographic error-correcting coding. Then, the error-correcting codewords are transmitted over a possibly noisy medium. Under such a conventional scheme, a cryptographic adversary would obtain the error-correcting codewords that have been transmitted across the medium and first use an appropriate standard error-correcting decoder to remove any errors due to noise. In this way, the adversary easily recovers uncorrupted cipher text. Then, the adversary would attack the uncorrupted cipher text cryptoanalytically.

A public-key cryptosystem based on algebraic coding theory was proposed by McEliece that allows the possibility of joint encryption and coding in one unit. One advantage of McEliece's cryptosystem is that an adversary cannot remove noise-caused errors from ciphertext without a required decryption key, and therefore the adversary cannot obtain uncorrupted cipher text for attacking. On the contrary, the adversary must directly attack ciphertext that is possibly corrupted by noise. The noise is random and unpredictable and significantly complicates any cryptoanalytic attack by the adversary.

McEliece's cryptosystem, however, requires a large key, of about 67,072 bytes. Therefore, McEliece's cryptosystem is impractical for general communication systems. McEliece's cryptosystem is discussed by T. A. Berson in “Failure Of The McEliece Public-Key Cryptosystem Under Message-Resend And Related-Message Attack” in Advances in Cryptology-CRYPTO'97, LNCS 1294, 1997, pp. 213-220. Berson's article explains that McEliece's cryptosystem suffers from two further weaknesses. These further weaknesses are failure to message re-send attack, i.e., failure to protect any message which is encrypted more than once, and failure to related-message attack, i.e., failure to protect any messages which have a known linear relation to one another.

### SUMMARY OF THE INVENTION

What is needed is a cryptosystem and methodology that overcome at least some drawbacks and limits, especially those discussed in the Background section, of existing cryptosystems. The present invention satisfies these and other needs.

According to one embodiment of the present invention, a method for encryption and transmission of information comprises the steps of: inserting at least one encryption key element into data elements that are to be communicated, yielding an extended information sequence, said data elements that are to be communicated hereinafter referred to as the source data elements; encoding said extended information sequence using an error-correcting code, yielding an extended codeword; removing at least one element of said extended codeword, leaving a punctured extended codeword; and transmitting said punctured extended codeword across a medium.

According to another embodiment of the present invention, a method for decrypting information on a receiving side of a transmission comprises the steps of: receiving input data, wherein said input data includes error-correction code with missing elements and with errors, said missing elements corresponding to information removed on a sending side of said transmission, said information being based on a key, said key already known on said receiving side of said transmission; and automatically decoding said input data based on said key to recover a message despite said errors, wherein without knowledge of said key, said automatically decoding would not have been possible due to lack of said missing elements.

According to another embodiment of the present invention, a method for encryption comprises the steps of: error-correction encoding at least an information sequence to be communicated, based on a private encryption key and according to a predetermined first scheme, yielding an error-correction-encoded information sequence; subjecting at least a portion of said error-correction-encoded information sequence to errors, yielding a corrupted error-correction-encoded information sequence; and transferring said corrupted error-correction-encoded information sequence toward a receiver, wherein said receiver knows said private encryption key and is configured to, based on knowing said private encryption key, decrypt said received corrupted error-correction-encoded information sequence, including to compensate for errors in said received corrupted error-correction-encoded information according to a predetermined second scheme based on knowing said private encryption key.

According to another embodiment of the present invention, a system for encryption of information comprises: means for inserting at least one encryption key element into data elements that are to be communicated, yielding an extended information sequence, said data elements that are to be communicated hereinafter referred to as the source data elements; means for encoding said extended information sequence using an error-correcting code, yielding an extended codeword; and means for removing at least one element of said extended codeword, leaving a punctured extended codeword.

According to another embodiment of the present invention, a system for decrypting information on a receiving side of a transmission comprises means for receiving input data, wherein said input data includes error-correction code with missing elements and with errors, said missing elements corresponding to information removed on a sending side of said transmission, said information being based on a key, said key already known on said receiving side of said transmission; and means for automatically decoding said input data based on said key to recover a message despite said errors, wherein without knowledge of said key, said automatically decoding would not have been possible due to lack of said missing elements.

Still other embodiments of the invention are discussed in the remainder of the present patent document, or would be apparent to one of ordinary skill in the present art.

### BRIEF DESCRIPTION OF THE DRAWINGS

In order to more fully describe currently preferred embodiments of the present invention and the currently known best mode of the present invention, reference is made to the accompanying drawings. Understand that these drawings are not to be considered limitations in the scope of the invention, but are merely illustrative.

FIG. 1 is a schematic block diagram that illustrates transmission of a jointly encrypted and encoded message through a communication channel.

FIG. 2 is a schematic block diagram that illustrates an embodiment of the system schematically illustrated in FIG. 1, in which embodiment an error sequence/random noise is added to the coded message before transmitting through the communication channel.

FIG. 3 is a schematic block diagram that illustrates a particular embodiment of the system schematically illustrated in FIG. 2, in which embodiment coded data elements corresponding to the encryption key are removed.

FIG. 4 is a schematic block diagram that illustrates a particular embodiment of an algebraic coder that is schematically illustrated in FIG. 3, wherein the embodiment uses a non-systematic recursive convolutional code as the algebraic encoder.

FIG. 5 is a schematic block diagram that illustrates a particular embodiment, of the algebraic coder that is schematically illustrated in FIG. 3, wherein the embodiment uses a non-systematic turbo-code as the algebraic encoder.

FIG. 6 is a schematic diagram that illustrates a trellis structure of a rate ½ non-systematic recursive convolutional code associated with FIG. 4.

FIG. 7 is a schematic diagram that illustrates a trellis structure of a rate ½ non-systematic recursive convolutional code when a data element in the extended information sequence dₖ=1 is known to the decoder.

FIG. 8 is a schematic flow chart that illustrates a trace-forward decoding method according to an embodiment of the present invention.

FIG. 9 is a schematic flow chart that illustrates a trace-backward decoding method according to an embodiment of the present invention.

FIGS. 10 and 11 plot results obtained by an encoder using the modules schematically illustrated in FIG. 5 and the decoding methods schematically illustrated in FIGS. 8 and 9.

### DETAILED DESCRIPTION OF SPECIFIC EMBODIMENTS

The description above and below and the drawings of the present document focus on one or more currently preferred embodiment(s) of the present invention and also describe some exemplary optional features and/or alternative embodiments. The description and drawings are for the purpose of illustration and not limitation. Section titles below, if any, are terse and are for convenience only.

As will be further discussed, some embodiments of the present invention include or make use of one or both of two novel methods, namely a method of joint error-correcting coding and encryption, and/or a method of metric transition decoding.

In successfully integrating encryption and error-correcting coding into one process, some embodiments of the present invention achieve synergy and obtain a high level of secrecy and a reliable communication link, even and especially in the presence of high transmission noise. In successfully using metric transition decoding, some embodiments of the present invention obtain an integrated decryption and decoding process that has low complexity and therefore requires merely modest computational resources. Disadvantages of prior cryptosystems are avoided.

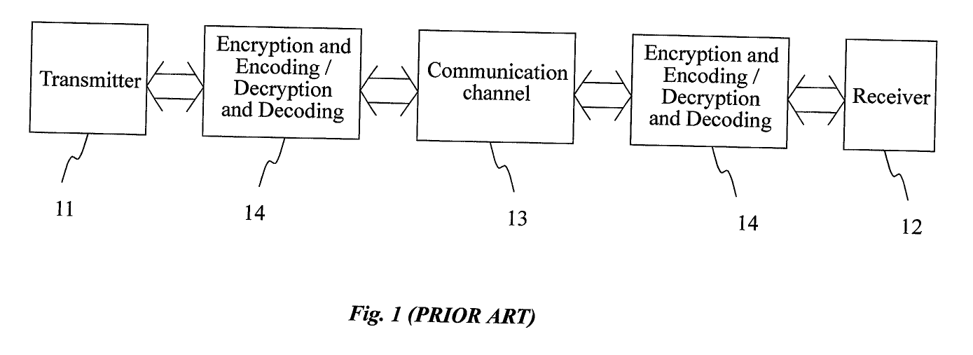

Referring to FIG. 1, a message M is to be transferred from a transmitter 11 to a receiver 12 through a communication channel 13. Each of the transmitter 11 and receiver 12 uses and/or includes a module 14 for encryption and encoding/decryption and decoding that is associated with methods for joint encryption and encoding/decryption and decoding. According to these methods, encryption and encoding are joined in a unified process, and decryption and decoding are joined in a unified process. In contrast, typical conventional communication systems keep encryption and encoding in separate, independent processes and keep decryption and decoding in separate, independent processes. As noted in the Background section, McEliece's cryptosystem does allow the possibility of joint encryption and coding; for this reason, FIG. 1 is labeled as “(PRIOR ART)”. However, when the module 14 illustrated in FIG. 1 uses components or methodology enabled by the present patent document that are not McEliece's public-key components or methodology, then the system illustrated in FIG. 1 is not prior art.

The module 14 may be embodied on any competent processing device, using any combination of software, firmware, and/or hardware. For example, the module 14 may be implemented on any competent general purpose computer or special purpose computing device running any operating system whatsoever, for example, Linux, UNIX, Microsoft Windows, Symbian EPOC, BeOS, or the like, or any other operating system. The processing device may be of any competent type, for example, client computers, server computers, personal or handheld computers, telephony devices, fax devices, television receivers/transmitters, video recording devices, television set-top boxes, cellular phones, pagers, personal digital assistants, modems, and/or computers or peripherals within or coupled to any type of network(s), and/or the like, or any other type, or any combination thereof. The network(s) may be of any type and may use any competent network protocol or topology or technology whatsoever, for example, the network(s) may include local-area, wide-area, and/or personal-area networks, for example, data, voice, and/or video networks, using any kind of communication medium or technology, for example, electrical and/or optical and/or acoustic conduction, wireless communication, and/or the like, or any others, or any combination thereof. For example, the module 14 may be embodied as software, stored on a storage medium, that directs one or more processors to execute methodology as will be further discussed.

In many typical conventional cryptosystems, an encryption key sequence generated by a stream cipher is mathematically combined to the source message using an exclusive OR function to generate an encrypted message. The encrypted message is then encoded by a channel encoder. In the preferred embodiment of the present invention, rather than using the exclusive OR function, an encryption key sequence is inserted into the source message sequence and then encoded together by an algebraic encoder.

In the preferred embodiment of the present invention, the system illustrated in FIG. 1 is a private key encryption system, in which a pre-agreed key sequence is assumed to be shared by both the transmitter and receiver. Communication of such a key sequence is preferable performed securely using public key methodology, for example, methodology described in U.S. Pat. No. 4,405,829 or any other public-key methodology. The methodologies known as “RSA public key cryptosystems” can effectively communicate and authenticate a key sequence between the transmitter and the receiver to thereby establish it as the pre-agreed key sequence. RSA is computationally expensive for high data rate cryptosystems, and therefore limiting its use merely to the establishing of the pre-agreed key sequence, and not to encryption of actual messages, is helpful.

In general, an encryption key sequence E can be generated by repeating the pre-agreed key sequence. However, it is preferable to use stream cipher techniques to generate a pseudo-random-sequence based on the pre-agreed key. The pseudo-random-sequence is used as the encryption key sequence E. A stream cipher technique such as RC4 is a preferred choice. The RC4 method was developed by Ron Rivest for RSA Data Security, Inc. The method is described by Bruce Schneier in “Applied cryptography Second Edition: Protocols, Algorithms, and Source Code in C”, John Wiley & Sons, Inc. 1996, pp. 397-398.

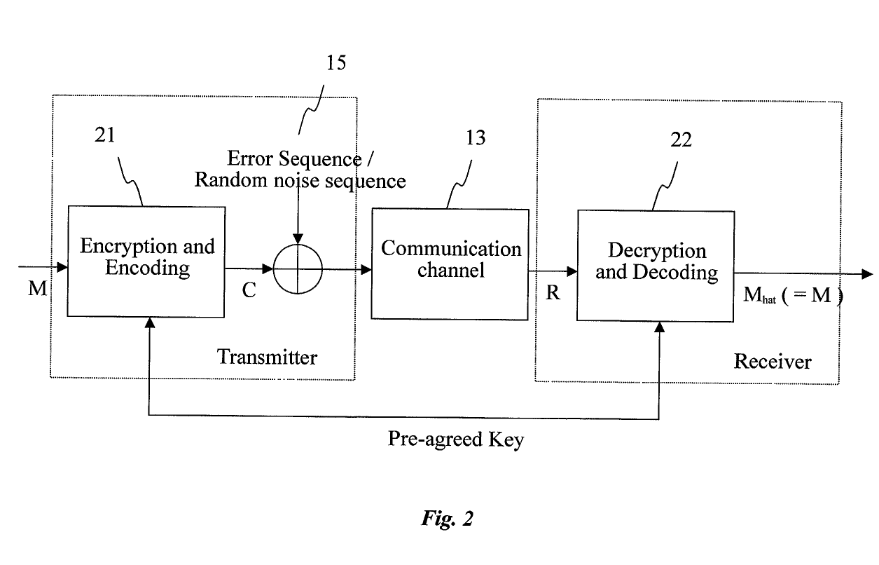

FIG. 2 illustrates an embodiment of the system illustrated in FIG. 1 where a message M is transferred from a transmitter 11 (of FIG. 1) to a receiver 12 (of FIG. 1). The message M is jointly encoded and encrypted by a module 21, using an encryption key sequence E that is derived from the pre-agreed key sequence. The encrypted codeword is C.

For an algebraic code, there is an associated error correcting value, which is the number of errors that can be corrected by the algebraic code. Assume that the algebraic code in module 14 (of FIG. 1) has an error correcting value t, a randomly generated error sequence 15 with weight smaller than or equal to t is added to the encrypted codeword C. If a communication channel 13 is noiseless, then it is preferable to set the weight of the error sequence 15 equal to t. In any event, the resulting corrupted encrypted codeword is transferred through the communication channel 13 to the receiver.

In typical communication channels, transmitting signals are corrupted by noise that has real values. A common communication channel model is the additive white Gaussion noise (AWGN) channel. In this model, noise with real values following Gaussian distribution is added to the transmitting signals.

Signal to noise ratio (SNR) is a value showing the ratio between the power of the signal and the noise. For a certain SNR, algebraic codes have their performances ranked by their bit error rates (BER) which are the rates of decoding errors. In the preferred embodiment of the present invention, if an algebraic code with a soft decoding method is used, random noise sequence 15 is added to the encrypted codeword. The power of the random noise is set, according to the expected noise level of the channel, such that the error-correcting capability of the algebraic code is not expected to be exceeded. The distribution of the random noise values may follow any probability distribution, for example, a Gaussian distribution.

On the receiver side, the received signals are contaminated with error sequence/random noise and channel noise. A joint decoding and decryption module 22 decodes and decrypts the received signals, using the encryption key sequence E. The output from the module 22, Mₕₐₜ, is an estimation of the originally transmitted source information sequence M.

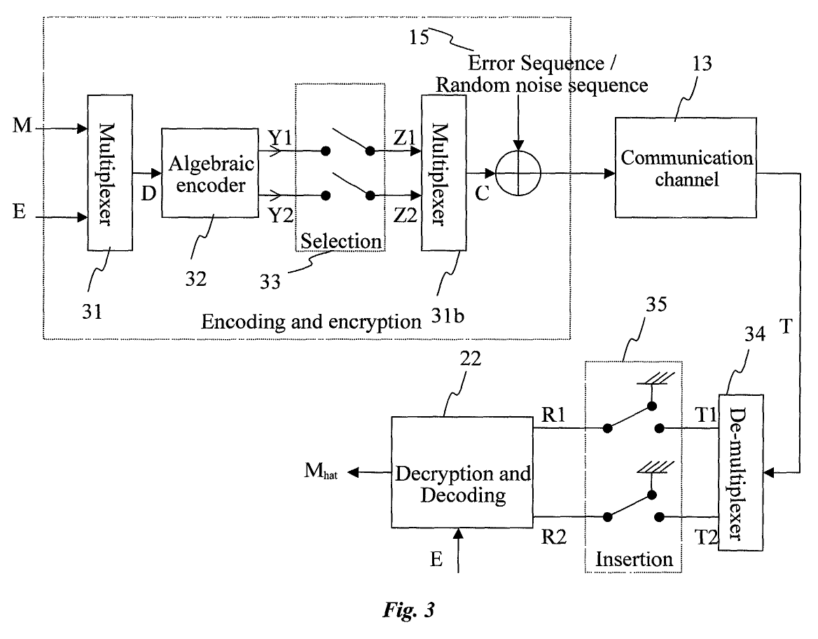

FIG. 3 illustrates a system implementing a method of the preferred embodiment of the invention, in an example where data elements in the message sequence M is multiplexed with data elements in the encryption key sequence B by a module 31. The resulting multiplexed sequence D is called an extended message sequence. The multiplexing may be, for example, in a one to one ratio. The multiplexed sequence D is then encoded by an algebraic encoding module 32. The algebraic encoder can be a block encoder or a convolutional encoder. For a rate ½ algebraic encoder, the encoding module 32 encodes D and produces two parity sequences, Y₁ and Y₂and Y₂ form an extended codeword. Y₁ and Y₂ are fed to a selection module 32. The selection module 32 punctures (i.e., removes) all the coded data elements corresponding to the encryption key sequence B and selects the coded data elements corresponding to the data elements in the source information sequence M to obtain the encrypted codeword.

For the following example,

| | | | | | | | |
|---|---|---|---|---|---|---|---|
| D | = | M₁ | E₁ | M₂ | E₂ | M₃ | E₃ . . . |
| Y1 | = | Y_{1,1} | Y_{1,2} | Y_{1,3} | Y_{1,4} | Y_{1,5} | Y_{1,6} . . . |
| Y2 | = | Y_{2,1} | Y_{2,2} | Y_{2,3} | Y_{2,4} | Y_{2,5} | Y_{2,6} . . . |

Y_{1,2},Y_{1,4}, Y_{1,6}. . . and Y_{2,2} , Y_{2,4},Y_{2,6} . . . are punctured from the extended codeword. The resulting codeword is Z₁ and Z₂where Z₁=Y_{1,1},Y_{1,3},Y_{1,5}. . . and Z₂=Y_{2,1}, Y_{2,3},Y_{2,5}. . . A multiplexing module 31b multiplexes and Z₁ and Z₂ together to form C, the encrypted codeword. C=Y_{1,1},Y_{2,1},Y_{1,3},Y_{2,3},Y_{1,5},Y_{2,5}. . . It should be noted that the values of the data elements of C are mathematically dependent on the encryption key data elements.

An error sequence/random noise sequence 15 is added to C, the encrypted codeword. The corrupted encrypted codeword is transferred through the communication channel 13. On the receiver side, a de-multiplexing module 34 de-multiplexes the transmitted signals T into two sequences T1 and T2. An insertion module 35 corresponding to the selection-module 33 has an insertion function that, for each punctured coded data element in the extended codeword, the module 35 inserts a zero value in the corresponding position of the transmitted signal sequences resulting in R1 and R2. A joint decoding and decryption module 22 decodes and decrypts R1 and R2 using the encryption key sequence E, producing Mₕₐₜ, an estimation of the original message sequence M. (As will be later discussed, the insertion module 35 may merely be a conceptual module.)

To an adversary, the encrypted codeword C is an over-punctured codeword. This is because the adversary does not know the encryption key sequence E. E has to be treated as part of the information bits to be transferred from the transmitter to the receiver. However, the selection module 33 punctures all the coded data elements corresponding to the encryption key data elements, the encrypted codeword C is a rate 1 code, which does not have any error correcting capability. Referring to FIG. 3, an error sequence/random noise sequence 15 is added to encrypted codeword C, and the resulting corrupted encrypted codeword C is sent through the communication channel 13. The adversary may tap into the communication channel and get the received signals R. In this case, R is corrupted by the error sequence/random noise sequence and possibly the channel noises. It is not possible for the adversary to decode the received signals using a normal decoder without the knowledge of the encryption key sequence.

For each data element in the message sequence, more than one encryption key data element can be inserted. A key insertion ratio can be defined to represent the ratio between the number of encryption key data elements and the source information data elements in the extended message sequence.

In general, there are two ways to increase the secrecy level of the embodiments being discussed of the invention. A first way is to increase the key insertion ratio—i.e., to have the multiplexing module 31 multiplex more than one sequence of encryption key data elements E to the source information sequence M. As a result, there would be more encryption key data elements than source information data elements in the extended message sequence D. From the adversary's point of view, the encrypted codeword will be a severely punctured codeword with code rate greater than 1. In such case, the adversary cannot even decode the error-free codeword. A second way to increase secrecy is to increase the weight of the error sequence, and/or to increase the power of the noise, to be added to the encrypted codeword. The more severely the encrypted codeword is corrupted, the more difficult it is for the adversary to carry out cryptanalysis. Therefore, an algebraic code with high error correcting capability is preferable for the system. In order to crack the presented cryptosystem, the adversary would want to estimate both the error sequence/random noise sequence and the encryption key sequence E. Both of the above-mentioned measures (namely, increased insertion/puncturing and increased contamination) would make it more difficult for the adversary to achieve the adversary's goal.

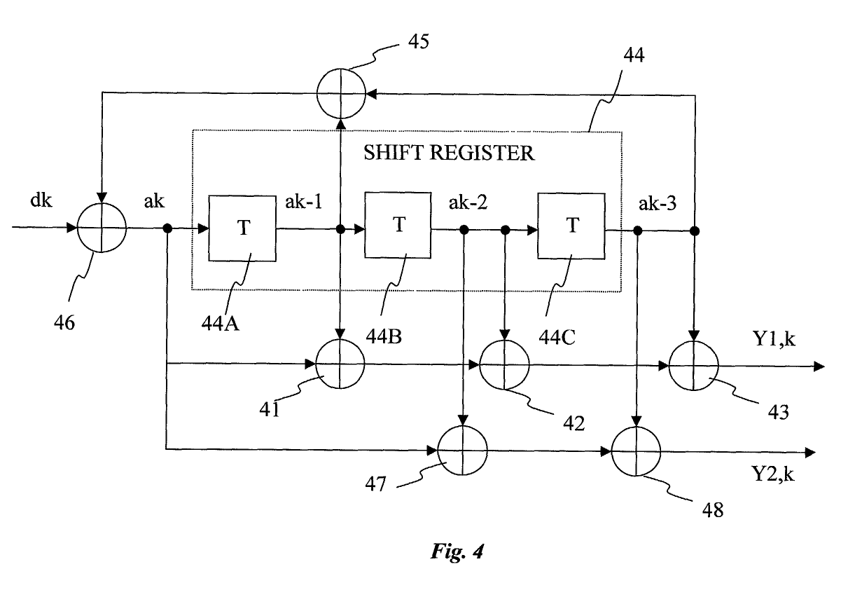

FIG. 4 illustrates an example of a non-systematic recursive convolutional code (NSRCC), proposed by Oliver M. Collins, Oscar Y. Takeshita, and Daniel J. Costello, Jr., in “Iterative Decoding of Non-Systematice Turbo-codes” in International Symposium on Information Theory, 2000. Proceedings, IEEE, 2000 page(s): 172. NSRCC can be used in the present invention as an algebraic encoder. There are two reasons to choose such coding schemes from the convolutional code family. One reason is that such schemes are non-systematic, and, therefore, the source information data elements are not directly shown in the coded sequences of the codeword. The other reason is that such coding schemes are recursive, which implies that for each coded element in the coded sequences, its value depends on all the preceding information data elements. Such recursion makes it difficult for the adversary to break the codeword into sub-blocks and then to crack the sub-blocks individually.

The coder illustrated in FIG. 4 associates two coded values Y1,k, Y2,k to each extended information data element dk. The data element Y1,k is computed by means of combinations 41, 42 and 43 of at least three binary elements contained in a shift register 44. In its cells 44A, 44B and 44C, the shift register 44 contains not the previous source information values dk-1, dk-2 and dk-3 but distinct intermediate values ak-1, ak-2 and ak-3.

The coded value of Y1,k is determined on the basis of particular values ak obtained by a mathematical combination and, for example, exclusive OR gates 45 and 46, of the source data element dk with at least one of the preceding intermediate values ak-1, ak-2 and ak-3.

The data element Y2,k is computed similarly by means of combinations 47 and 48 of at least three binary elements contained in the shift register 44.

NSRCC is a rate ½ code that can be applied to the system illustrated in FIG. 3 to function as the algebraic encoder 32. In this case, random noise following a Gaussian distribution is preferably added to the encrypted codeword as illustrated by the error sequence/random noise sequence 15 of FIG. 3.

However, the error correcting capability of NSRCC is only relatively moderately powerful. It is preferable to use more powerful error correcting codes such as Turbo-Codes as described in U.S. Pat. No. 5,446,747. Turbo-Codes embody a powerful error-correcting method that gives performance approaching the Shannon limit over a Gaussian noise channel. Turbo-Codes can correct large numbers of errors. Therefore, using Turbo-Codes, large numbers of errors can be added to the encrypted codeword to achieve a high level of secrecy. The complexity of encoding and decoding of Turbo-Codes is moderate. Therefore, a Turbo-Code is a preferable algebraic code to be used, except that the originally proposed Turbo-Code as stated in U.S. Pat. No. 5,446,747 is a systematic code, which means the source information sequence are directly attached to the codeword.

Non-systematic Turbo-Codes, as proposed by Oliver M. Collins, Oscar Y. Takeshita and Daniel J. Castello, Jr., “Iterative Decoding of Non-systematic Turbo-Codes” in International Symposium on Information Theory, 2000. Proceedings, IEEE, 2000 page(s): 172, are therefore preferably used in the present invention. As the article shows, non-systematic recursive convolutional codes (NSRCC's) are used as the component codes for Turbo-Codes. The resulting non-systematic Turbo-Codes preserve the powerful error-correcting capabilities of the systematic Turbo-Codes while avoiding directly attaching the source information sequence to the codeword.

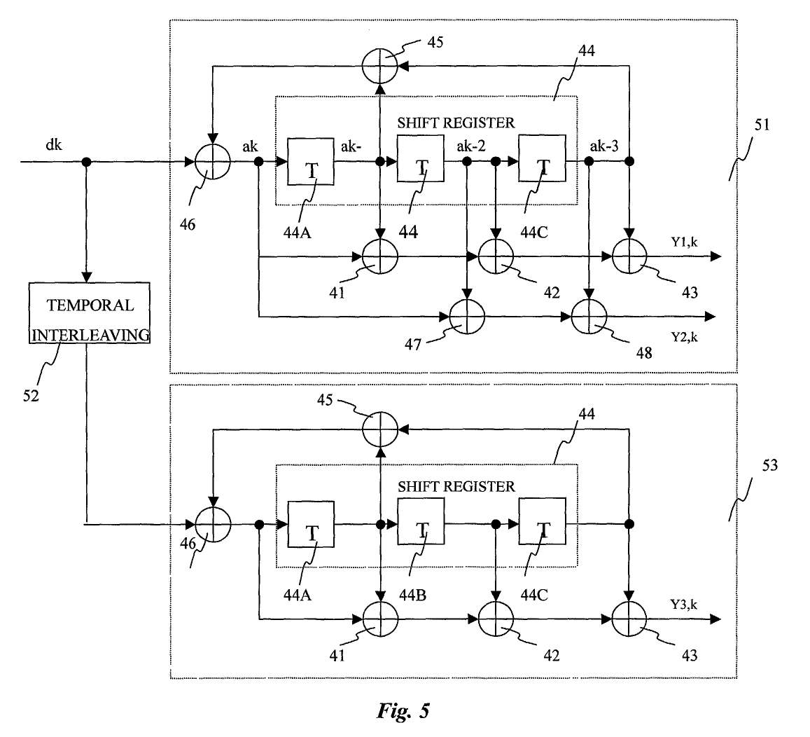

FIG. 5 shows a particular embodiment of a non-systematic Turbo-Code. Module 51 is the NSRCC as shown in FIG. 4. Extended information sequence D, which is indicated in FIG. 5 by its element dk, is first applied to this module to produce sequences Y1 and Y2, which are indicated in FIG. 5 by their respective elements Y1,k and Y2,k. D is also applied to an interleaving module 52. The interleaving module 52 carries out random interleaving wherein the order of the sequence D is randomly permuted.

Use of an interleaver to permute the sequence of source information data elements, in Turbo-Codes, can greatly improve the performance of the codes.

The interleaved extended information data elements are applied to a non-systematic recursive convolutional coding module 53 to produce parity sequence Y3, which is indicated in FIG. 5 by its element Y3,k. This module 53 is equivalent to the non-systematic recursive convolutional encoder illustrated in FIG. 4 that produces Y1.

As mentioned above, a metric transition decoding method that can jointly decode and decrypt the received signals in a combined process is used by, and/or is included in, an embodiment of the present invention. The method introduces only a small amount of extra computation compared to conventional component decoding algorithms.

Both block codes and convolutional codes can be decoded by the maximum a posteriori (MAP) decoding method, which was published by Bahl, Cocke, Jelinek and Raviv in “Optimal Decoding of Linear Codes for Minimizing Symbol Error Rate”, IEEE Transactions on Information Theory, March 1974, pages 284-287. This decoding method may be referred to as the BCJR method. A modified MAP decoding method for turbo decoding was proposed by C. Berrou, A. Glarvienx, and P. Thitimajshima, in “Near Shannon limit error-correcting coding and decoding: Turbo-codes,” in ICC'93, Geneva, Switzerland, May 93, pp. 1064-1070.

The preferred embodiment of the present invention presents a modified MAP decoding method that has a metric transition technique that can efficiently decode the received signals using the knowledge of encryption key data elements. The modified MAP decoding method is further discussed below.

Consider an NSRCC with a constraint length K; at time k the encoder state Sₖ is represented by a K-uple

Sₖ=(aₖ, aₖ₋₁, . . . ,a_{k-K+2}) (1)

Assume that there are L source information data elements, and that, after the insertion process, the extended information data elements sequence {dₖ} has N independent data elements dₖ, taking values of zero and one with equal probability and the encoder initial state S₀ and final state S_{N} are both equal to zero, i.e.,

S₀=S_{N}=(0,0, . . . ,0)=0. (2)

For the system illustrated by FIG. 3, assuming that the communication channel is noiseless and that discrete random Gaussian noise is added to the encrypted codeword sequence, C₁^{L}={C₁, . . . , Cₖ, . . . ,C_{L}}, where Cₖ=(Z_{1,k}, Z_{2,k}), and the resulting transmitted sequence is T₁^{L}={T₁, . . . , Tₖ, . . . ,T_{L}}. T₁ ^{L} is applied to the De-multiplexing module 34 and insertion module 35, yielding R₁^{N}={R₁, . . . ,Rₖ, . . . ,R_{N}} where Rₖ=(Y_{1,k}, Y_{2,k}) is defined as follows:

Case I: When Rₖ corresponds to a source information data element,

Y_{1,k}=(2Y_{1,k}−1)+iₖ

Y_{2,k}=(2Y_{2,k}−1)+qₖ (3a)

where iₖ and qₖ are two independent noises with the same variance σ².

Case II: When Rk corresponds to an encryption key data element whose coded data elements are punctured,

Y_{1,k}=0

Y_{2,k}=0. (3b)

Using the definition of conditional probability, Pr{A|B} means the conditional probability of event A given B, and Pr{A;B} means the joint probability of events A and B. The a posteriori probability (APP) of a decoded bit dₖ is Pr{dₖ=i/observation}, i=0,1. The logarithm of likelihood ratio (LLR), Λ(dₖ) associated with each decoded bit dₖ is given by

$$Λ ( {d}_{k} ) = log \frac{Pr \{ {d}_{k} = 1 / observation \}}{Pr \{ {d}_{k} = 0 / observation \}} \qquad ( 4 )$$

The APP can be derived from the joint probability λₖⁱ(m) defined by

λₖⁱ(m)=Pr{dₖ=i, Sₖ=m/R₁^{N}} (5)

where m is the index of the states.

The APP of a decoded bit dₖ is thus equal to

$$Pr \{ {d}_{k} = i / {R}_{i}^{N} \} = {\sum }_{m} {λ}_{k}^{i} ( m ) , i = 0 , 1. \qquad ( 6 )$$

From (4) and (5), the LLR Λ(dₖ) can be written as

$$Λ ( {d}_{k} ) = log \frac{{\sum }_{m} {λ}_{k}^{1} ( m )}{{\sum }_{m} {λ}_{k}^{0} ( m )} . \qquad ( 7 )$$

From the definition (5) of λₖⁱ(m), the LLR Λ(dₖ) can be written as

$$Λ ( {d}_{k} ) = log \frac{{\sum }_{m} {\sum }_{{m}^{′}} Pr \{ {d}_{k} = 1 , {S}_{k} = m , {S}_{k - 1} = {m}^{′} , {R}_{1}^{k - 1} , {R}_{k} , {R}_{k + 1}^{N} \}}{{\sum }_{m} {\sum }_{{m}^{′}} Pr \{ {d}_{k} = 0 , {S}_{k} = m , {S}_{k - 1} = {m}^{′} , {R}_{1}^{k - 1} , {R}_{k} , {R}_{k + 1}^{N} \}} \qquad ( 8 )$$

Using BAYE'S RULE and observing that events after time k are not influenced by observation R₁^{k} and bit dₖ if state Sₖ is known, the LLR Λ(dₖ) is equal

$$Λ ( {d}_{k} ) = log \frac{{\sum }_{m} {\sum }_{{m}^{′}} Pr \{ {R}_{k + 1}^{N} / {S}_{k} = m \} Pr \{ {S}_{k - 1} = {m}^{′} / {R}_{1}^{k - 1} \} Pr \{ {d}_{k} = 1 , {S}_{k} = m , {R}_{k} / {S}_{k - 1} = {m}^{′} \}}{{\sum }_{m} {\sum }_{{m}^{′}} Pr \{ {R}_{k + 1}^{N} / {S}_{k} = m \} Pr \{ {S}_{k - 1} = {m}^{′} / {R}_{1}^{k - 1} \} Pr \{ {d}_{k} = 0 , {S}_{k} = m , {R}_{k} / {S}_{k - 1} = {m}^{′} \}} . \qquad ( 9 )$$

To compute the LLR Λ(dₖ), Bahl proposed three probability functions αₖ(m), βₖ(m) and γᵢ(Rₖ,m′,m) defined by

αₖ(m)=Pr{Sₖ=m/R₁^{k}} (10)

$${β}_{k} ( m ) = \frac{Pr \{ {R}_{k + 1}^{N} / {S}_{k} = m )}{Pr \{ {R}_{k + 1}^{N} / {R}_{1}^{k} )} \qquad ( 11 )$$

γᵢ(Rₖ,m′,m)=Pr{dₖ=i, Sₖ=m, Rₖ/Sₖ₋₁=m′} (12)

Using the definitions from (9), (1 0), (11) and (12), Λ(dₖ) can be written as

$$Λ ( {d}_{k} ) = log \frac{{\sum }_{m} {\sum }_{{m}^{′}} {γ}_{1} ( {R}_{k} , {m}^{′} , m ) {α}_{k - 1} ( {m}^{′} ) {β}_{k} ( m )}{{\sum }_{{m}^{′}} {\sum }_{m} {γ}_{0} ( {R}_{k} , {m}^{′} , m ) {α}_{k - 1} ( {m}^{′} ) {β}_{k} ( m )} . \qquad ( 13 )$$

In the preferred embodiment of the present invention, coded data elements corresponding to the encryption key data elements are punctured from the codeword. The decoding method has two cases to handle. The BCJR method is used for the received signals corresponding to the coded data elements of source information sequence, and a metric transition method is used for the punctured coded data elements corresponding to the encryption key data elements.

Case I: Use BCJR method for the received signals corresponding to coded data elements of source information data elements:

The probabilities αₖ(m) and βₖ(m) can be recursively calculated from probability γᵢ(Rₖ,m′,m) where

$$\begin{matrix}{α}_{k} ( m ) = log {\sum }_{{m}^{′}} \frac{{\sum }_{i = 0}^{1} {γ}_{i} ( {R}_{k} , {m}^{′} , m ) {α}_{k - 1} ( {m}^{′} )}{{\sum }_{m} {\sum }_{{m}^{′}} {\sum }_{i = 0}^{1} {γ}_{i} ( {R}_{k} , {m}^{′} , m ) {α}_{k - 1} ( {m}^{′} )} \\ & ( 14 ) \\ {β}_{k} ( m ) = log \frac{{\sum }_{{m}^{′}} {\sum }_{i = 0}^{1} {γ}_{i} ( {R}_{k + 1} , {m}^{′} , m ) {β}_{k - 1} ( {m}^{′} )}{{\sum }_{m} {\sum }_{{m}^{′}} {\sum }_{i = 0}^{1} {γ}_{i} ( {R}_{k + 1} , m , {m}^{′} ) {α}_{k} ( {m}^{′} )} . & ( 15 )\end{matrix}$$

The probability γᵢ(Rₖ,m′,m) can be determined from the transition probabilities of the random Gaussian noise and transition probabilities of the encoder trellis. From (12), γᵢ(Rₖ,m′,m) is given by

γᵢ(Rₖ,m′,m)=p(Rₖ/dₖ=i, Sₖ=m, Sₖ₋₁=m′)·q(dₖ=i/Sₖ=m, Sₖ₋₁=m′) ·π(Sₖ=m/Sₖ₋₁=m′) (16)

where p(•/•) is the transition probability of the Gaussian random valuable. Conditionally to (dₖ=i, Sₖ=m, Sₖ₋₁=m′), y_{1,k} and Y_{2,k} are two un-correlated Gaussian variables, then

p(Rₖ/dₖ=i, Sₖ=m, Sₖ₋₁=m′)=p(y_{I,k}/dₖ=i, Sₖ=m, Sₖ₋₁=m)·P(y_{2,k}/dₖ=i, Sₖ=m, Sₖ₋₁=m′) (17)

As a convolutional encoder is a deterministic machine, q(dₖ=i/Sₖ=m, Sₖ₋₁=m′) is equal to 0 or 1. The transition state probabilities π(Sₖ=m/Sₖ₋₁=m′) of the trellis are defined by the encoder input statistic. In general, Pr{dₖ=1}=Pr{dₖ=0}=½. Since there are two possible transitions from each state, π(Sₖ=m/S_{k,1 =m′)=}½for each of the transitions.

Case II: Metric transition method for the punctured coded data elements corresponding to encryption key data elements:

In the receiver, coded data elements corresponding to encryption key data are not received, since they were punctured at the transmitter and were not transmitted. In the preferred embodiment of the invention, it is not possible to derive the state transition probabilities corresponding to an encryption key data element merely from the received signals. Fortunately, the receiver actually does not need to calculate alpha and beta function values for the encryption key data elements because the receiver already knows the value of these encryption key data elements, given that the preferred embodiment of the present invention is a private key cryptosystem. However, the MAP method needs such alpha and beta function values for the recursive calculation of the alpha and beta function values corresponding to other elements, namely, the source-information data elements.

For the metric transition method, values of alpha and beta functions corresponding to an encryption key data element can be copied from alpha and beta function values corresponding to the source information data elements.

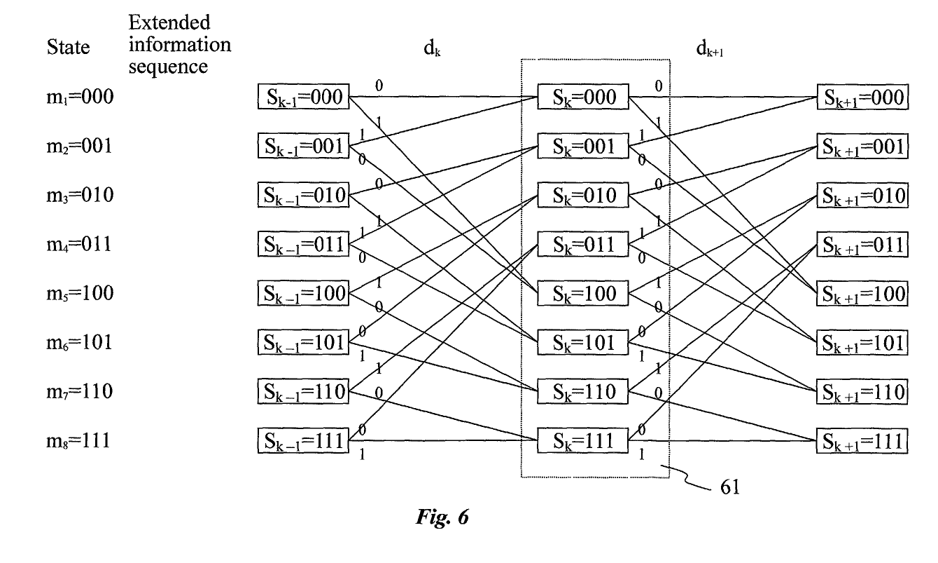

FIG. 6 shows a trellis diagram of the NSRCC that is illustrated in FIG. 4. There are eight states in the trellis, m₁, m₂, . . . , m₈ which equal to 000, 001, . . . ,111 respectively. For each data element in the extended information sequence, dₖ, there are eight associated states as shown in module 61. The links between the states corresponding to two data elements are the trellis paths. For example, there is a trellis path linking state 000 of dₖ to state 000 of dₖ₊₁ with a label of 0 while there is a trellis path linking state 000 of dₖ to state 100 of dₖ₊₁ with a label of 1. These mean that when dₖ₊₁=0, state 000 of dₖ goes to state 000 of dₖ₊₁and when dₖ₊₁, =1, state 000 of dₖ transits to state 100 of d_{k+1.}

Assume that dₖ is an encryption key data element whose coded data elements are punctured in module 33. Also, assume that dₖ₋₁ is a data element from the source information sequence and that αₖ₋₁(m) is calculated from (14) and stored in memory. Since coded data elements of dₖ are not transferred through the communication channel, it is not possible to use (14) to calculate αₖ(m).

The receiver, however, knows the value of dₖ. Observe that when it is known whether dₖ=0 or 1, there will be only one transition between any state of dₖ₋₁ and any state of dₖ. For example, when dₖ =1,

state of dₖ₋₁ 000 001 010 011 100 101 110 111

transition to state of dₖ 100 000 101 001 010 110 011 111

In the BCJR method, the alpha functions represent the probabilities of states in the trace forward decoding method.

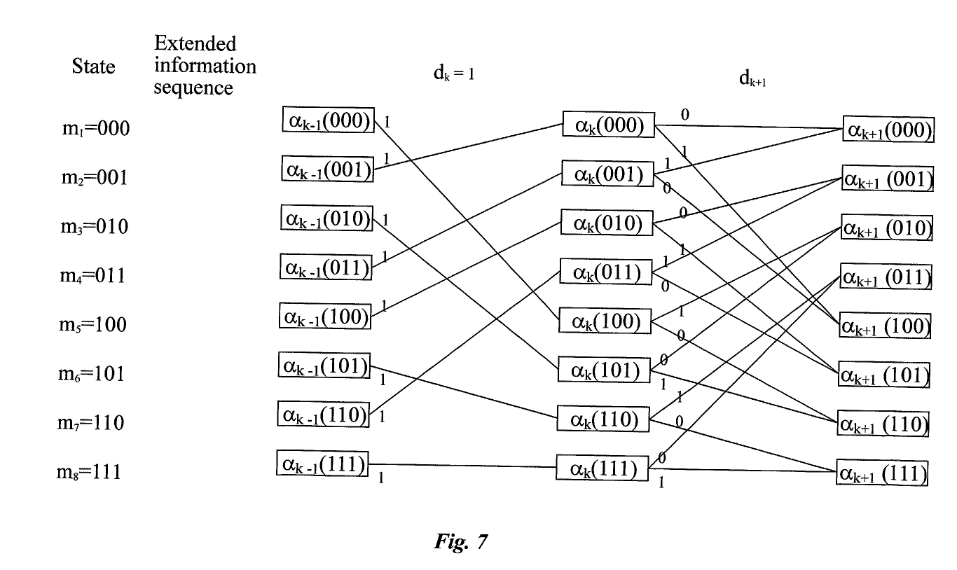

As illustrated in FIG. 7, when dₖ=1 is given, there is only one link between two states, and the probabilities of the two states are equal. In particular:

αₖ(100)=αₖ₋₁(000)

αₖ(000)=αₖ₋₁(001)

αₖ(101)=αₖ₋₁(010)

αₖ(001)=αₖ₋₁(011)

αₖ(010)=αₖ₋₁(100)

αₖ(110)=αₖ₋₁(101)

αₖ(011)=αₖ₋₁(110)

αₖ(111)=αₖ₋₁(111) (18)

The use of the insertion module 35 (of FIG. 3) is for ease of illustration to designate the positions of coded elements in the received signals. If an observation Rₖ corresponds to an encryption key data element, the value of Rₖ is (0,0). In a real system, the insertion module 35 can be omitted and the decoding method can simply use indexes to locate positions of the encryption key data elements.

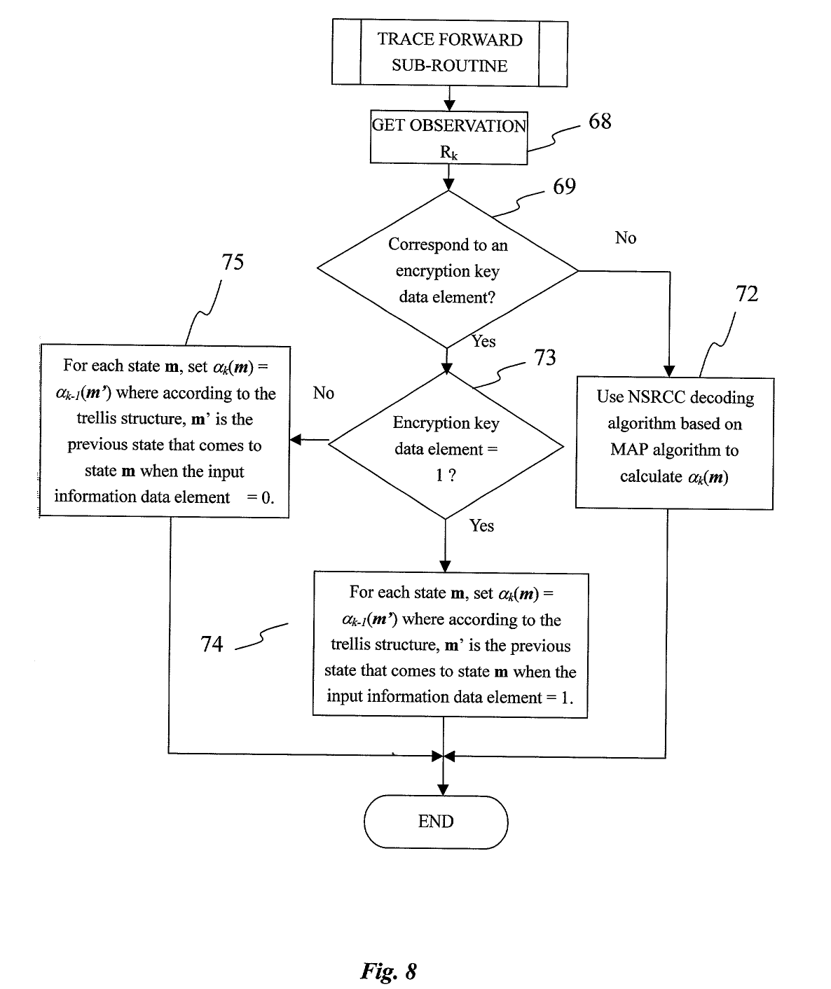

A metric transition method for calculating alpha functions is shown in FIG. 8. The decoder gets (68) an observation Rₖ and checks (69) if it corresponds to an encryption key data element. If not, the NSRCC decoding method based on MAP is used (72) to calculate αₖ(m). If yes, then the decoder checks (73) whether the encryption key data element equals to 1. If yes, then (74) for each state m, set αₖ(m)=αₖ₋₁(m′) where according to the trellis structure, m′ is the previous state that comes to state m when the input information data element =1. Otherwise, if the key data element is equal to 0, then (75) for each state m, set αₖ(m)=αₖ₋₁(m′) where according to the trellis structure, m′ is the previous state that comes to state m when the input information data element =0.

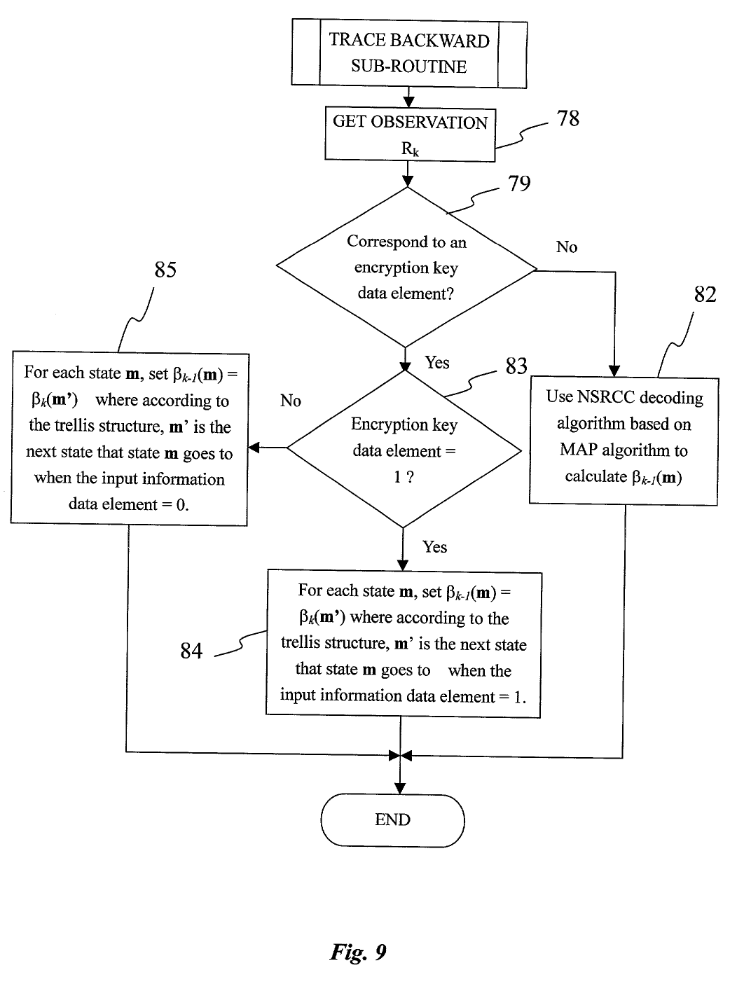

Similarly, a metric transition method for calculating beta functions is shown in FIG. 9. From FIG. 6, data element dₖ associates states Sₖ₋₁ and Sₖ. The recursive calculation of beta functions goes in a backward direction. Referring to equation (15), βₖ₋₁(m) is calculated from the observation Rₖ, βₖ(m) and αₖ₋₁(m). The decoder gets (78) an observation Rₖ and check (79) if it corresponds to an encryption key data element. If not, then (82) the NSRCC decoding method based on MAP method is used to calculate βₖ₋₁(m). If yes, then (83) the decoder checks whether the encryption key data element equals to 1. If yes, then (84) for each state m, set βₖ₋₁(m)=βₖ(m′) where according to the trellis structure, m′ is the next state that state m goes to when the input information data element =1. Otherwise, if the encryption key data element equals to 0, then (85) for each state m, set βₖ₋₁(m)=βₖ(m′) where according to the trellis structure, m′ is the next state that state m goes to when the input information data element =0.

Modified BCJR method with metric transition:

Step 0: Probabilities α₀(m) are initialized according to condition (2)

α₀(0)=1; α₀(m)=0 for all m not equal to 0. (19)

Probabilities β_{N}(m) are initialized similarly

β_{N}(0)=1; β_{N}(m)=0 for all m not equal to 0. (20)

Step 1: For each observation Rₖ, if Rₖ corresponds to a source information data element, the probabilities αₖ(m) and γᵢ(Rₖ,m′,m) are computed using (14) and (16) respectively. If Rₖ corresponds to an encryption key data element, the probabilities of αₖ(m) are computed using the trace forward sub-routine illustrated in FIG. 8.

Step 2: When sequence R_{I}^{N} has been completely received, for each observation Rₖ, if Rₖ corresponds to a source information data element, probabilities βₖ₋₁(m) are compute using (15). If Rₖ corresponds to an encryption key data element, βₖ₋₁(m) are computed using the trace backward sub-routine shown in FIG. 9.

Step 3: For each decoded data element dₖ corresponding to a source information data element, the associated LLR is computed from (13).

Turbo decoding method is described by C. Berrou, A. Glarvienx, and P. Thitimajshima, “Near Shannon limit error-correcting coding and decoding: Turbo-codes,” in ICC'93, Geneva, Switzerland, May 93, pp. 1064-1070. The corresponding decoding method for non-systematic turbo-codes is described by Oliver M. Collins, Oscar Y. Takeshita, and Daniel J. Costello, Jr., in “Iterative Decoding of Non-Systematice Turbo-codes” in International Symposium on Information Theory, 2000. Proceedings, IEEE, 2000 page(s): 172. Using modified BCJR method with metric transition technique as described in FIGS. 8 and 9, the corresponding decoding method for the system shown in FIG. 3 using the algebraic encoder shown in FIG. 5 is achieved.

Referring to FIG. 5, there are three coded series, namely Y1, Y2 and Y3 from the encoder output. The received signals R is thus composed by three data element sequences R1, R2 and R3, corresponding to Y1, Y2 and Y3 respectively. The iterative decoding method of non-systematic Turbo-Codes with metric transition technique is summarized.

Step 1: Initialize the a prior LLR, Le 1, of the source information elements for the first encoder to zero values, assuming equally likely and independent and identically distributed (IID) information data elements.

Step 2: Using received signals R1 and R2, and the a priori LLR of the source information data elements for the first encoder Le1, use the modified BCJR method with metric transition to compute the a posteriori LLR, La1, of the source information data elements.

Step 3: Compute the a priori LLR, Le2, of the source information data elements for the second encoder. Le2 equals to the interleaved values of La1-Le1, according to the interleaver design of the turbo-code used in the system.

Step 4: Using received signals R3, and the a priori LLR, Le2, of the source information data elements for the second encoder, use the modified BCJR method with metric transition to compute the a posteriori LLR, La2, of the interleaved source information data elements.

Step 5: Compute the a priori LLR, Le1, of the source information data elements for the first encoder. Le1 equals to the de-interleaved values of La2-Le2, according to the interleaver design of the turbo-code used in the system.

Step 6: If this is the last iteration, make a decision by using the sequence of de-interleaved LLR La2; otherwise, proceed to the next iteration starting at step 2.

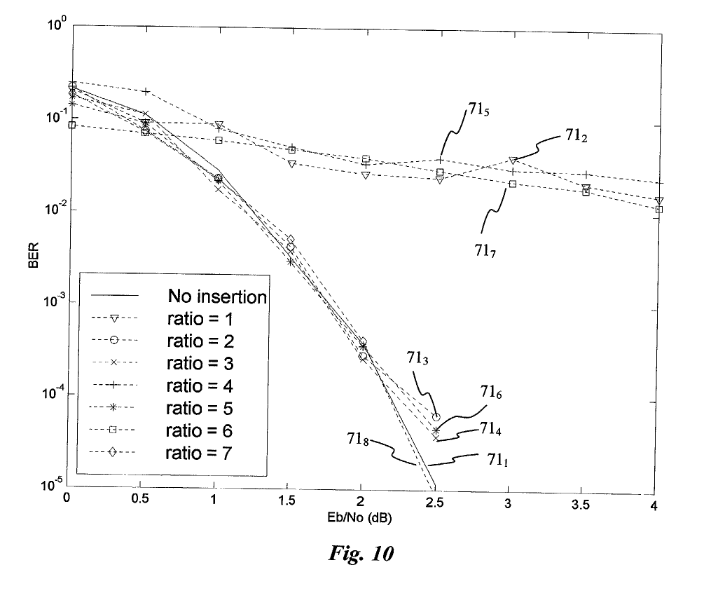

In FIG. 10, curves 71₁, to 71₈ show simulation results obtained by means of an encoder using the modules illustrated in FIG. 5 and the decoding method illustrated in FIGS. 8 and 9. In the simulation, both information sequence and coded sequence are binary. A small interleaver size of 200 bits has been chosen as many communication systems have packet sizes around 200 bits. The code rate is ⅓. Curve 71, corresponds to the BER curve of the non-systematic turbo-code as illustrated in FIG. 5, without any inserted key bits to message sequence. An error rate of 10⁻⁵ is achieved with SNR at about 2.5 dB. Curves 71₂, 71₃, . . . , 71₈ correspond to BER curves of the non-systematic turbo-code illustrated in FIG. 5 with encryption key insertion ratios equal to 1, 2, . . . ,7 respectively. Curves 71₃, 71₄, 71₆, and 71₈ corresponding to key insertion ratios 2, 3, 5, and 7 perform closely to curve 71_{1,} especially when SNR is smaller than 2 dB. Particularly, curve 71₈ corresponding to insertion ratio 7 achieves a BER of 10⁻⁵ at SNR 2.5 dB which is similar to that of curve 71_{1.}

However, curves 71₂, 71₅ and 71₇ corresponding to key insertion ratios 1, 4 and 6 have poor performances which cannot match with that of curve 71₁.

The results suggest that for the coding scheme as illustrated in FIG. 5, with interleaver size 200 bits, key insertion ratio is best set to 7. Other acceptable key insertion ratios are 2, 3, and 5. However, key insertion ratios 1, 4 and 6 should not be used. The degradations of the performances of the schemes using insertion ratios 1,4 and 6 are due to the fact that the present invention punctures the coded data elements corresponding to the encryption key data elements in module 33. Such puncturing will change the code structure of the codewords. Some insertion patterns will result in new code structures with small minimum Hamming weight, leading to poor performances. Therefore, simulations are helpful for finding out the best insertion pattern for an algebraic code.

For an interleaver size 200, assuming that insertion ratio is 7, the length of the pre-agreed key sequence can be set to 1400 bits or 175 bytes. This key size is small and thus is acceptable to most practical systems. If stream ciphers are used to generate the encryption key sequence, the pre-agreed key sizes can be flexibly assigned to match the requirement of the stream ciphers.

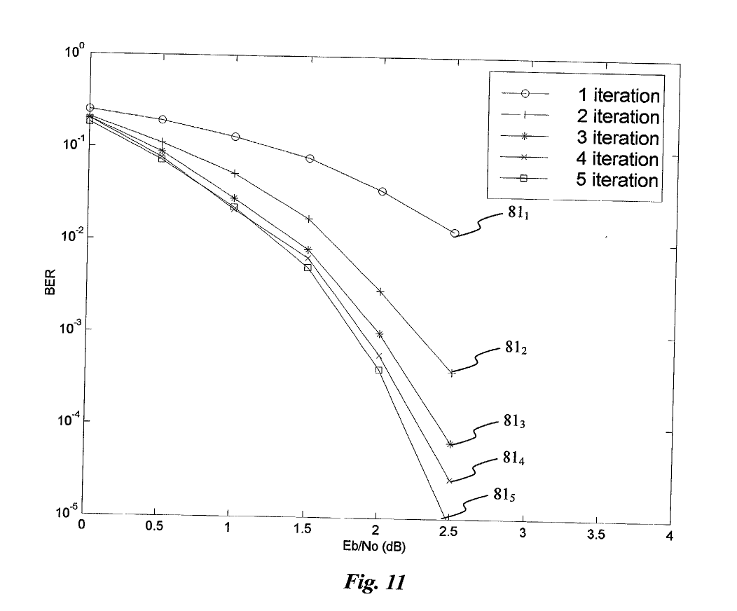

FIG. 11 illustrates the performance of the coding module illustrated in FIG. 5 with decoding methods illustrated in FIG. 8 and FIG. 9, with interleaver size of 200 bits and key insertion ratio equals to 7. Curves 81₁, 81₂, . . . ,81₅ plot the BER performance curves corresponding respectively to 1,2, . . . , 5 decoding iterations. The performance, as indicated by the curves, improves as the number of iteration is increased from 1 to 5. It is expected that with more decoding iterations, the performance will improved still further. As can be seen, with encryption key data elements inserted to the message sequence and corresponding coded data elements punctured off, the embodiment the present invention can effectively decode corrupted received signals utilizing the knowledge of the encryption key data elements and the performance follows that of the original Turbo-Codes as stated in U.S. Pat. No. 5,446,747.

As can be seen, some embodiments of the present invention can provide systems and methods for joint error-correcting coding and encryption with small key size that are applicable to general communication systems. For example, such methods can provide systems and methods of enabling secured and reliable communication over wireless communication systems. Notably, some embodiments of the present invention provide joint error-correcting coding and encryption such that stream ciphers can be integrated with error-correcting codes to achieve higher levels of secrecy. Some embodiments of the present invention provide joint error-correcting coding and encryption that are immune to the message re-send and related-message attack. Some embodiments of the present invention provide joint error-correcting coding and encryption that are computationally inexpensive for both encoding and decoding processes. Accordingly, joint error-correcting coding and encryption may be achieved, with joint decryption and decoding using soft decoding.

An insert and puncture scheme is preferred. In this scheme, the encryption key data elements are inserted to the source information sequence to form an extended information sequence. The extended information sequence is encoded by an algebraic code, for example a non-systematic turbo-code which uses non-systematic recursive convolutional codes (NSRCC's) as component codes, yielding an extended codeword. The coded data elements on the coded series corresponding to the encryption key data elements are punctured from the extended codeword, resulting in an encrypted codeword. An error sequence or random noise is added to the encrypted codeword before it is finally transferred through a communication channel.

A pre-agreed key sequence is known to both the sender and the receiver. The encryption sequence used can be generated by repeating the pre-agreed key sequence, or based on the pre-agreed key sequence generated from a stream cipher such as RC4. Since a stream cipher produces a pseudo-random-sequence, if this sequence is used as the encryption key sequence, within a period of time, the encryption key data elements for different encoding block are different. Therefore, the joint error-correcting coding and encryption are immune to message re-send or related-message attacks as the same message produces different encrypted codewords at different time within the period of the stream cipher employed in the system.

The maximum a posteriori (MAP) type algorithm introduced by Bahl, Cocke, Jelinek, and Raviv in “Optimal Decoding of Linear Codes for Minimizing Symbol Error Rate”, IEEE Transactions on Information Theory, March 1974, pp. 284-287, is particularly useful as a component decoding algorithm in Turbo-Codes. In a turbo decoder, the MAP algorithm calculates the a posteriori probability (APP) estimates of the source information data elements of the codeword. These probability estimates are used for the second MAP decoder. The second MAP decoder calculates the a posteriori probability (APP) estimates of the source information data elements of the codeword, based on the received signals and the APP from the first MAP decoder. The produced probability estimates are then iteratively used for the first MAP decoder. There are three fundamental probability functions in the MAP algorithm, namely the forward and backward state probability functions (the alpha and beta functions, respectively) and the a posteriori transition probabilities (the gamma function). The alpha function corresponding to an information data element can be recursively calculated based on the alpha functions corresponding to the preceding information data elements. Similarly, the beta function corresponding to an information data element can be recursively calculated based on the beta functions corresponding to the succeeding information data elements.

Coded data elements in the coded series corresponding to encryption key data elements are punctured, the decoder cannot derive the alpha and beta functions corresponding to an encryption key data element from the received signals. Fortunately, the receiver actually does not need to calculate such alpha and beta functions, as it knows the values of the encryption key data elements, for example, because a private key cryptosystem is implemented. However, the MAP algorithm needs such alpha and beta functions for the recursive calculation of the alpha and beta functions corresponding to other information data elements.

The metric transition algorithm which, based on the value of an encryption key data element and the trellis structure of the algebraic code, copies the alpha and beta functions corresponding to the preceding and succeeding source information data elements to the alpha and beta functions corresponding to the encryption key data element. Since the alpha and beta functions are simply copied, the complexity of the decoding algorithm is still low as compare to the original MAP algorithm.

Throughout the description and drawings, example embodiments are given with reference to specific configurations. It will be appreciated by those of ordinary skill in the present art that the present invention can be embodied in other specific forms. Those of ordinary skill in the present art would be able to practice such other embodiments without undue experimentation. The scope of the invention is not limited merely to the specific example embodiments of the foregoing description, but rather is indicated by the appended claims. All changes that come within the meaning and range of equivalents within the claims are intended to be considered as being embraced within the scope of the claims.

What is claimed is:

1. A method for encryption and transmission of information, comprising the steps of:
inserting at least one encryption key element into data elements that are to be communicated, yielding an extended information sequence, said data elements that are to be communicated hereinafter referred to as the source data elements;
encoding said extended information sequence using an error-correcting code, yielding an extended codeword;
removing at least one element of said extended codeword, leaving a punctured extended codeword; and
transmitting said punctured extended codeword across a medium.

2. The method according to claim 1, wherein said error-correcting code is an algebraic code.

3. The method according to claim 2, wherein said algebraic code is a non-systematic recursive convolutional code.

4. The method according to claim 1, wherein said error-correcting code is a non-systematic turbo-code using non-systematic recursive convolutional codes as component codes.

5. The method according to claim 1, wherein said inserting step is according to a predetermined ratio of number of encryption key elements per number of source data elements.

6. The method according to claim 1, wherein each said at least one element of said extended codeword that is removed in the removing step is mathematically associated to at least one encryption key element.

7. The method according to claim 1, wherein each said at least one element of said extended codeword that is removed in the removing step is mathematically associated to at least one encryption key element and at least one source data element.

8. The method according to claim 1, further comprising introducing errors into said punctured extended codeword, yielding a corrupted punctured extended codeword.

9. The method according to claim 8, wherein:
said error-correcting code has an error-correcting capacity;
said step of introducing errors comprises adding an error sequence to said punctured extended codeword; and
said error sequence has a weight that does not exceed said error correcting capacity of said algebraic code.

10. The method according to claim 1, further comprising adding real valued random noise to said punctured extended codeword before said transmitting step.

11. The method according to claim 10, wherein:
said error-correcting code has an error-correcting capacity;
said medium includes a noisy communication channel; and
said real valued random noise and noise from said medium are together calculated to introduce errors substantially no greater than said error-correcting capacity of said error-correcting code.

12. The method according to claim 1, wherein said at least one encryption key element is at least one element of an encryption key sequence; and said encryption key sequence is a private key available to both a sender and a receiver.

13. The method according to claim 12, wherein said encryption key sequence is a pseudo-random sequence generated from a pre-agreed stream cipher based on a key that is known to both said sender and said receiver.

14. A method for receiving and decoding coded information that was coded according to the coding method of claim 12, wherein said receiving and decoding method comprises:
receiving said coded information; and
decoding said received coded information based on said encryption key sequence.

15. The method according to claim 14, wherein said coded information includes said punctured extended codeword, with errors, and said decoding step corrects for said errors based on said encryption key sequence to obtain said source data elements.

16. The method according to claim 14, wherein:
said decoding step comprises estimating said source data elements from said received coded information using said encryption key sequence;
said estimating step comprises determining quantities associated with states, the states corresponding to said source data elements and said encryption key element; and
said determining step comprises using a quantity associated with a state corresponding to a source data element as a quantity associated with a state corresponding to one of said at least one encryption key element based on value of said one of said at least one encryption key element and based on state transition structure.

17. The method according to claim 16, wherein:
said coded information includes said punctured extended codeword, with errors,
said state transition structure is based on said error-correcting code; and
an element of said extended codeword that is removed in the removing step is mathematically associated to said encryption key element, and in said taking step, value of said encryption key element is known to said receiver due to said receiver's knowledge of said private key.

18. The method according to claim 17, wherein said determining step comprises computing said quantity associated with a state corresponding to a source data element using maximum a posteriori (MAP) decoding.

19. The method according to claim 18, wherein said decoding step or steps implement maximum likelihood decoding methods of BCJR algorithm type with weight decisions in junction with said metric transition technique.

20. A method for decrypting information on a receiving side of a transmission, comprising the steps of:
receiving input data, wherein said input data includes error-correction code with missing elements and with errors, said missing elements corresponding to information removed on a sending side of said transmission, said information being based on a key, said key already known on said receiving side of said transmission; and
automatically decoding said input data based on said key to recover a message despite said errors, wherein without knowledge of said key, said automatically decoding would not have been possible due to lack of said missing elements.

21. A method for encryption, comprising the steps of:
error-correction encoding at least an information sequence to be communicated, based on a private encryption key and according to a predetermined first scheme, yielding an error-correction-encoded information sequence;
subjecting at least a portion of said error-correction-encoded information sequence to errors, yielding a corrupted error-correction-encoded information sequence; and
transferring said corrupted error-correction-encoded information sequence toward a receiver, wherein said receiver knows said private encryption key and is configured to, based on knowing said private encryption key, decrypt said received corrupted error-correction-encoded information sequence, including to compensate for errors in said received corrupted error-correction-encoded information according to a predetermined second scheme based on knowing said private encryption key.

22. The method according to claim 21, further comprising:
receiving, by the receiver, the corrupted error-correction-encoded information sequence; and
based on knowing said private encryption key, decrypting said received corrupted error-correction-encoded information sequence, including compensating for errors in said received corrupted error-correction-encoded information according to a predetermined second scheme based on knowing said private encryption key.

23. A system for encryption of information, comprising:
means for inserting at least one encryption key element into data elements that are to be communicated, yielding an extended information sequence, said data elements that are to be communicated hereinafter referred to as the source data elements;
means for encoding said extended information sequence using an error-correcting code, yielding an extended codeword; and
means for removing at least one element of said extended codeword, leaving a punctured extended codeword.

24. A system for decrypting information on a receiving side of a transmission, comprising:
means for receiving input data, wherein said input data includes error-correction code with missing elements and with errors, said missing elements corresponding to information removed on a sending side of said transmission, said information being based on a key, said key already known on said receiving side of said transmission; and
means for automatically decoding said input data based on said key to recover a message despite said errors, wherein without knowledge of said key, said automatically decoding would not have been possible due to lack of said missing elements.

25. A system for encryption, comprising:
means for error-correction encoding at least an information sequence to be communicated, based on a private encryption key and according to a predetermined first scheme, yielding an error-correction-encoded information sequence; and
means for subjecting at least a portion of said error-correction-encoded information sequence to errors, yielding a corrupted error-correction-encoded information sequence; and
means for transferring said corrupted error-correction-encoded information sequence toward a receiver, wherein said receiver knows said private encryption key and is configured to, based on knowing said private encryption key, decrypt said received corrupted error-correction-encoded information sequence, including to compensate for errors in said received corrupted error-correction-encoded information according to a predetermined second scheme based on knowing said private encryption key.
